(19) United States
(12) Patent Application Publication
(10) Pub. No.: US 2012/0111259 A1
(43) Pub. Date: May 10, 2012

(54) Flag Display Apparatus

(75) Inventors: James A. Swisher, Jacksonville, FL (US); Brittany Toler, Midlothian, VA (US); Timothy A. Lamm, Midlothian, VA (US); Shannon L. Eastwood, Glen Allen, VA (US)

(73) Assignee: Evergreen Enterprises, Inc., Richmond, VA (US)

(21) Appl. No.: 13/291,988

(22) Filed: Nov. 8, 2011

Related U.S. Application Data
(60) Provisional application No. 61/456,599, filed on Nov. 9, 2010.
(60) Provisional application No. 61/574,287, filed on Jul. 29, 2011.
(60) Provisional application No. 61/627,212, filed on Oct. 7, 2011.

(51) Int. Cl. G09F 17/00

(52) U.S. Cl. 116/173

(57) ABSTRACT

The present invention includes a flag display apparatus comprising a flag arm configured to support an edge of a flag and a base configured to attach to a flag pole, wherein the flag arm is secured to the base and wherein the base is configured to allow the flag arm to rotate around the flag pole. In any number of embodiments, the flag display apparatus further comprises a support ring and means for attaching the flag to the flag arm. Alternatively, a sleeve, loops or ties on a flag specially adapted for use with a flag display assembly can be used to secure the flag to the flag arm. In any number of embodiments, the flag pole fits into a mounting sleeve that is mounted onto a building or structure. The mounting sleeve can also be affixed to the ground for a vertical flag pole.

This application claims the benefit of U.S. provisional application Ser. No. 61/456,599, filed Nov. 9, 2010 and entitled “Flag-Arm;” U.S. provisional application Ser. No. 61/574,287, filed Jul. 29, 2011 and entitled “Flag Buddy Flag Pole Extension;” and U.S. provisional application Ser. No. 61/627,212, filed Oct. 7, 2011 and entitled “Displaying Two or More Flags on the Same Pole;” disclosures of which are incorporated herein by reference.

### FIELD OF THE INVENTION

The present invention relates to a display apparatus and more specifically a flag or banner display assembly.

### BACKGROUND OF THE PRESENT INVENTION

The concept of mounting a flag to a pole is well known. Often, a flag pole is mounted to a building. Sometimes this flag pole is mounted such that it runs substantially parallel to the ground and other times the pole is mounted at an angle, for example at a 45 degree angle relative to the building face. In fact, one of the most common ways to display a flag is on an angled pole mounted to a building. It is a simple, low cost technique that is adaptable to just about any location and environment. However, several issues exist with hanging a flag or banner in such a way. For example, when at rest, the hanging flag folds over on itself, thereby obscuring the design, image or message on the flag. If the flag is rain soaked, even a substantial wind will not unfurl the flag and a frozen flag is stuck at least until the material defrosts. The same is true for a flag hanging on a vertical pole perpendicular to the ground. In addition, wind can easily wrap the fabric around the pole and further obscure the design.

Furthermore, even if a flag pole is mounted to a building such that the pole is substantially parallel to the ground and the flag hangs straight down such that the design, message or image is not obscured, wind can quickly manipulate the fabric such that it wraps around the pole and once again obscures the design on the material. More often than not, a tangled flag or banner remains tangled until the owner notices the problem and then takes the time to correct it. Instead, the owner may just remove the flag or banner entirely to avoid the effort required to continuously fix a knotted flag.

Another problem with previous flag display techniques is that the image on a flag or banner can only be viewed from certain directions. Previous inventions have employed poles that spin such that the flag can be viewed from all directions. However, these systems are often expensive and difficult to install. Furthermore, they necessitate a special type of flag pole and are not adaptable to previously installed flag poles. In addition, if the flag pole does not extend far enough from the building, the flag can rub along the roof or building as it spins, thereby causing wear and tear damage to the flag. The present invention allows the flag display assembly and the attached flag to spin 360 degrees around the pole instead of requiring a spinning pole to be installed. Additionally, an extension arm described herein can be utilized to extend the mounted flag beyond the roof line and thereby alleviate the wear and tear damage resulting from contact with the building or roof.

There exists a need for an apparatus that provides a full-view mounting of a flag or banner regardless of the weather. There exists a further need for a tangle-free mounting of a flag or banner. The present invention addresses these needs and provides a tangle-free, full-view mounting of the flag or banner, thereby alleviating the time and energy required for an owner to fix a tangled flag or manually change the viewing direction.

### SUMMARY OF THE PRESENT INVENTION

The present invention includes a flag display apparatus comprising a flag arm configured to support an edge of a flag and a base configured to attach to a flag pole, wherein the flag arm is secured to the base and wherein the base in configured to allow the flag arm to rotate around the flag pole. In any number of embodiments, the flag display apparatus further comprises a support ring and means for attaching the flag to the flag arm. Means for attaching the flag to the flag arm can include, but is not limited to, nylon pull ties, twine, clips, etc. Alternatively, a sleeve (also referred to as a pocket), loops or ties on a flag specially adapted for use with a flag display assembly can be used to secure the flag to the flag arm. The flag arm can be a substantially straight and cylindrical rod that the top edge of a flag is attached to such that the image on the flag is always displayed. In addition, the flag arm can be permanently or removably attached to the base, which fits around a flag pole. The support ring also fits onto the flag pole and prevents the base of the flag display assembly from sliding down the pole. In any number of embodiments, the flag pole fits into a mounting sleeve that is mounted onto a building or structure. The mounting sleeve can also be affixed to the ground for a vertical flag pole.

With the flag display apparatus in place, the flag is transformed into a “wing” that can catch the wind such that the flag is able to “fly” or spin 360 degrees around a flag pole. Once the wind subsides, the flag returns to a full view, at rest position. The material is not tangled by the wind. In some cases, because of the flag's ability to spin 360 degrees around the pole, an extension arm may be desirable to keep the flag from coming in contact with the roof as the flag rotates in flight. Contact with the roof can cause the flag to wear prematurely.

### BRIEF DESCRIPTION OF THE DRAWINGS

FIG. 1 is a front perspective view of the flag display assembly installed on a flag pole and a flag attached according to an embodiment of the present invention.

FIG. 1A is a front perspective view of a flag specially adapted to be used with a flag display assembly according to an embodiment of the present invention.

FIG. 2 is a side view of the flag display assembly according to an embodiment of the present invention.

FIG. 3 is a detailed side view of the flag display assembly of FIG. 2.

FIG. 4 is a detailed top view of the base and arm of the flag display assembly of FIG. 2.

FIG. 5 is a detailed side view of the base and arm of the flag display assembly of FIG. 2.

FIG. 6 is a detailed end view of the base and arm of the flag display assembly of FIG. 2.

FIG. 7 is a detailed front perspective view of the base and arm of the flag display assembly of FIG. 2.

FIG. 8 is a side view of a flag display assembly according to an alternative embodiment of the present invention.

FIG. 9 is a detailed top view of the flag display assembly of FIG. 8.

FIG. 10 is an exploded top perspective view of the base and threaded flag arm of the flag display assembly of FIG. 8.

FIG. 11 is an exploded side perspective view of the base and threaded flag arm of the flag display assembly of FIG. 8.

FIG. 12 is a detailed top view of the hinged outer casing of the base of FIG. 10

FIG. 13 is a detailed top view of the interior roller bearing assembly of the base of FIG. 10.

FIG. 14 is a detailed perspective view of a roller bearing housing segment of FIG. 13.

FIG. 15 is a detailed view of an end cap according to an embodiment of the present invention.

FIG. 16 is an exploded view of an end cap and flag arm according to an embodiment of the present invention.

FIG. 17 is a detailed view of an end cap installed on a flag arm and a flag clip installed on the end cap according to an embodiment of the present invention.

FIG. 18 is a detailed front view of a flag clip according to an embodiment of the present invention.

FIG. 19 is a detailed side view of the flag clip of FIG. 18.

FIG. 20 is a photograph showing a front perspective view of a flag clip of FIG. 18 in the open position.

FIG. 21 is a photograph showing a front perspective view of a flag clip of FIG. 18 in the closed position.

FIG. 22 is a photograph showing a front perspective view of the bottom surface of the flag clip of FIG. 18 in the open position.

FIG. 23 is a photograph showing a front perspective view of a flag clip attached to a clip ring according to an embodiment of the present invention.

FIG. 24 is a photograph showing a front perspective view of a clip ring according to an embodiment of the present invention.

FIG. 25 is a photograph showing a front perspective view of the flag clip and clip ring of FIGS. 23 and 24 in use.

FIG. 26 is a photograph showing a side perspective view of a flag clip in the open position according to an embodiment of the present invention.

FIG. 27 is a photograph showing a side perspective view of a flag clip of FIG. 26 in the closed position.

FIG. 28 is a photograph showing a top perspective view of the flag clip of FIG. 26 in the closed position.

FIG. 29 is a front perspective view of a flag display assembly according to an alternative embodiment of the present invention.

FIG. 30 is a front view of a flag mounting extension assembly used to connect two poles to each other according to an embodiment of the present invention.

FIG. 31 is a detailed front view of the flag mounting extension assembly according to an embodiment of the present invention.

FIG. 32 is a front view of a flag mounting extension assembly installed in a mounting sleeve according to an embodiment of the present invention.

FIG. 33 is a front view of a flag mounting extension assembly according to an embodiment of the present invention.

FIG. 34 is a photograph of a front view of a flag mounting extension assembly according to an embodiment of the present invention.

FIG. 35 is a front view of a flag pole extension assembly according to an embodiment of the present invention.

FIG. 36 is a front view of the flag pole extension assembly of FIG. 35 installed in a mounting sleeve.

FIG. 37 is a photograph of two flag display assemblies installed on a flag pole according to an embodiment of the present invention.

### DETAILED DESCRIPTION OF THE PREFERRED EMBODIMENTS

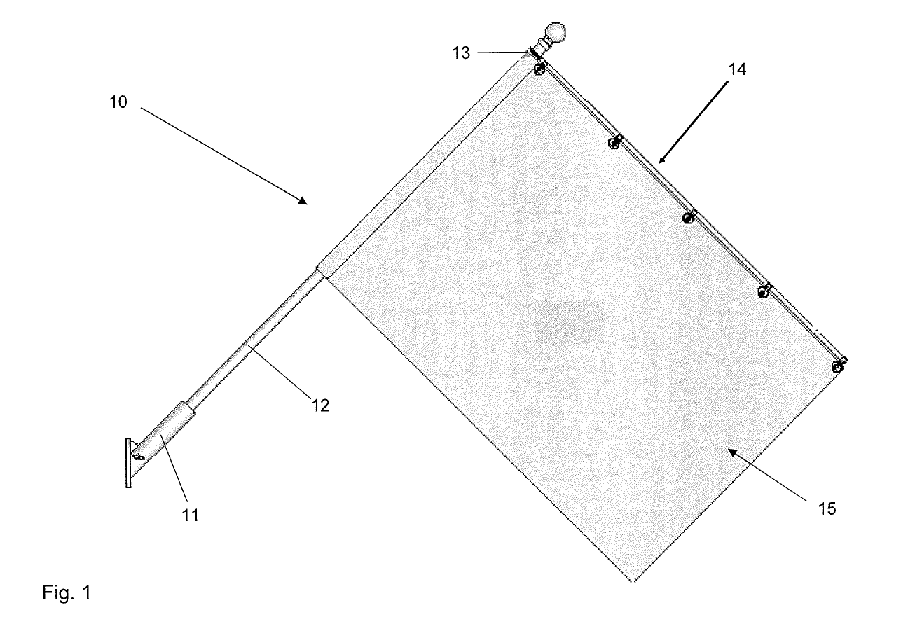

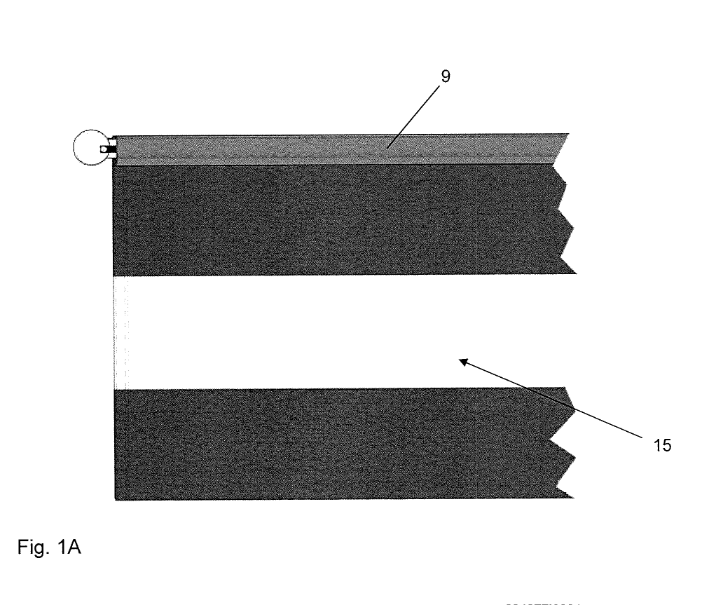

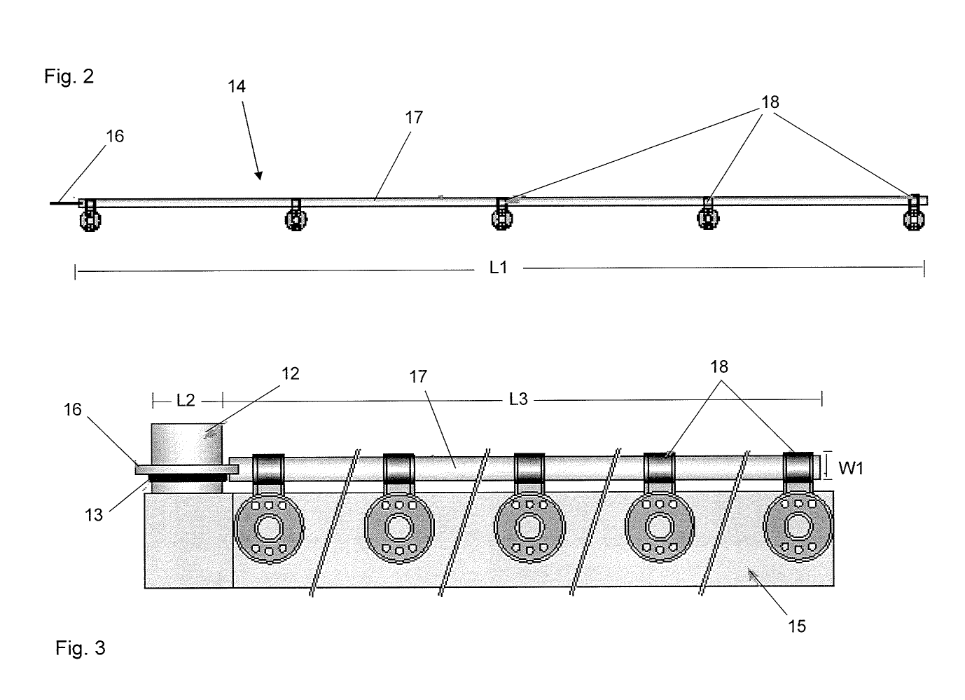

In the flag display assembly, as shown in FIGS. 1 through 3, elements of the flag display assembly 14 as shown include: a flag arm 17; a support ring 13; a base 16 and at least one clip 18. Other means for attachment including, but not limited to, nylon pull ties or twine, can be used in place of the clips 18. In an alternative embodiment, as shown in FIG. 1A, a flag 15 can be specially adapted to be used with a flag display assembly such that the top edge of the flag can be a sleeve or pocket that slips over the flag arm 17, thereby eliminating the need for clips. In alternative embodiments, the flag 15 includes loops or ties along the top edge such that the flag 15 is adapted to be used with a flag display assembly without needing clips 18. To install a flag on the flag display assembly, the support ring 13 is slid onto a flag pole 12 to a desired location. The base 16 (or base and attached flag arm 17 if the two pieces are not separable) are secured to the flag pole 12 such that the flag pole 12 passes through the cylindrical cavity in the center of the base 16 and the base 16 rests on the support ring 13. In some embodiments, the top ball end of a flag pole is removable to facilitate installation of the flag. If the top end of the flag pole 12 is removable, the support ring 13 can be installed before installing a base 16. If the base 16 can be opened, the base 16 can be installed before or after installing the support ring 13. In some embodiments, the top end of the flag pole is not removable and the support ring 13 and base 16 may need to be installed from the bottom end of the flag pole 12. If this is necessary and the base does not open, the base 16 should be installed before securing the support ring 13. Once the base 16 and support ring 13 are in place, a sleeve on a side edge of the flag 15 can be slipped over the flag pole 12 such that the pole 12 passes through the sleeve and extends past the bottom edge of the flag. Again, if the top end of the flag pole is removable, the side sleeve of a flag may be secured to the pole 12 before installing the base and support ring. Finally, using the clips 18 or other means of attachment, the top edge of the flag 15 is secured to the flag arm 17 of the flag display assembly 14.

The flag arm 17 can be a substantially straight and cylindrical rod that attaches to the top edge of a flag 15. The flag arm 17 is hollow in any number of embodiments. The flag arm may be made from any number of materials such as plastic or metal. Plastic or light-weight metals such as aluminum, for example, are preferable. The flag arm 17 has a length L3 and width W1. The length L3 and width W1 can vary to fit different sizes of flags. In an embodiment, for example, L3 is 41.5″ and W1 is 0.35″. In a preferred embodiment, the length L3 is equal to or slightly longer than the top edge of the flag 15. Furthermore, the flag arm 17 is permanently or removeably attached to the base 16. The flag arm 17 and base 16 have a length L1 when connected to one another.

As shown in FIG. 3, the base is secured to a flag pole 12. The support ring 13 also attaches to the flag pole 12 and holds the flag display assembly in place by preventing the base of the flag display assembly from sliding down the pole. In any number of embodiments, the support ring 13 is a rubber O-ring that fits around a flag pole 12 at one end of the pole and can be moved to various positions on the pole as desired by the flag owner. In any number of embodiments, the flag pole 12 fits into a mounting sleeve 11 that is mounted onto a building or structure, as shown in FIG. 1, for example. The mounting sleeve can also be affixed to the ground for a vertical flag pole.

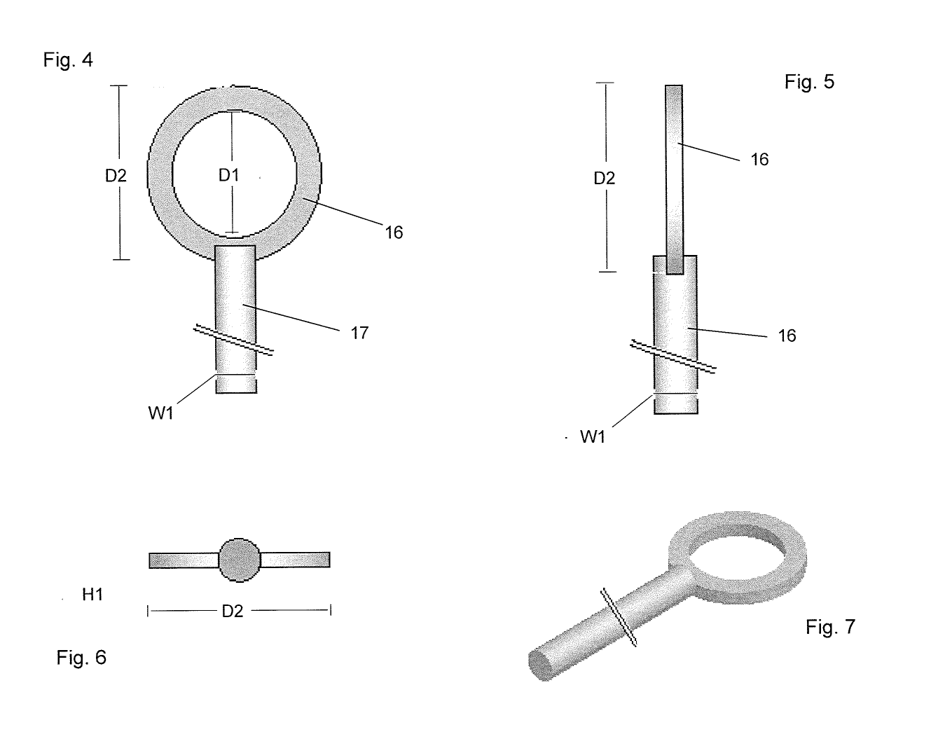

In any number of embodiments, as shown in FIGS. 4 through 7, for example, the base 16 can be permanently affixed to the flag arm 17. The base 16 is substantially cylindrical in shape and hollow. The base 16 has an inner diameter D1 and an outer diameter D2. The inner diameter D1 is sized such that it is slightly larger than the diameter of the flag pole 12 that the flag display assembly 14 is to be installed on. The inner diameter D1 can vary in size to fit different sized flag poles. In an embodiment, for example, the inner diameter D1 is 1.07″ and the outer diameter D2 is 1.5″. The base 16 can further have a height H1. The height H1 can vary. In one embodiment the height H1 is 0.15″. Alternatively, the base can include a threaded receiving end to receive a threaded flag arm such that the flag arm is removable. Because the base 16 forms a moveable ring around a flag pole that is held in place by a support ring 13, the entire flag display assembly 14 can spin or rotate 360 degrees around the flag pole 12. In addition, the base 16 can be adjustable to accommodate different sized flag poles.

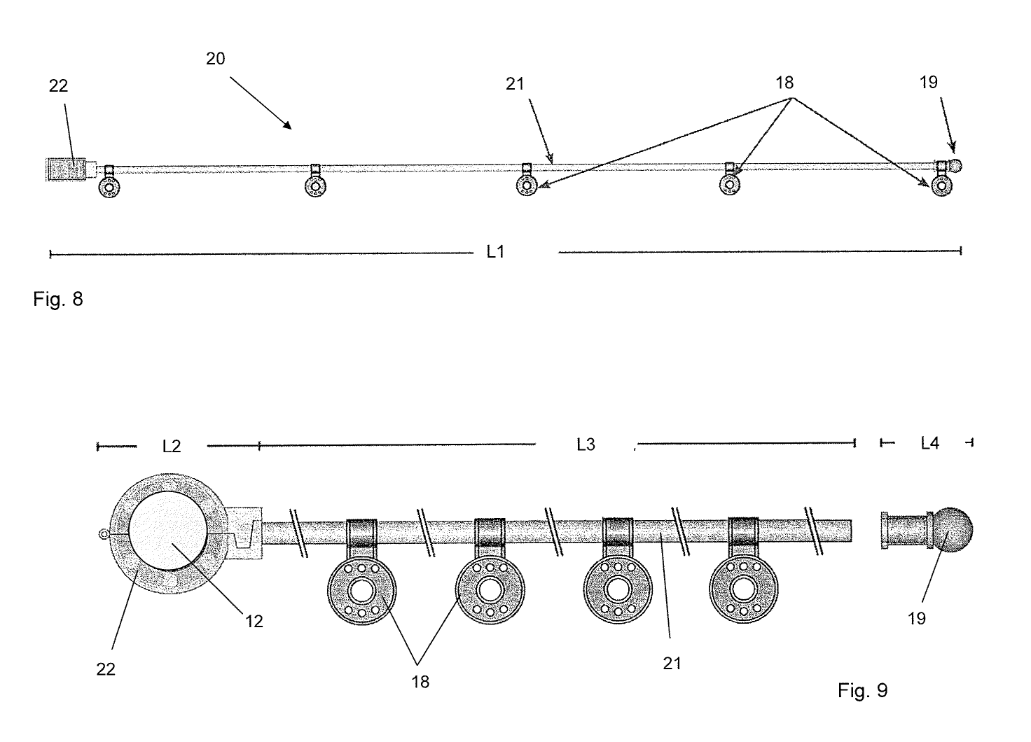

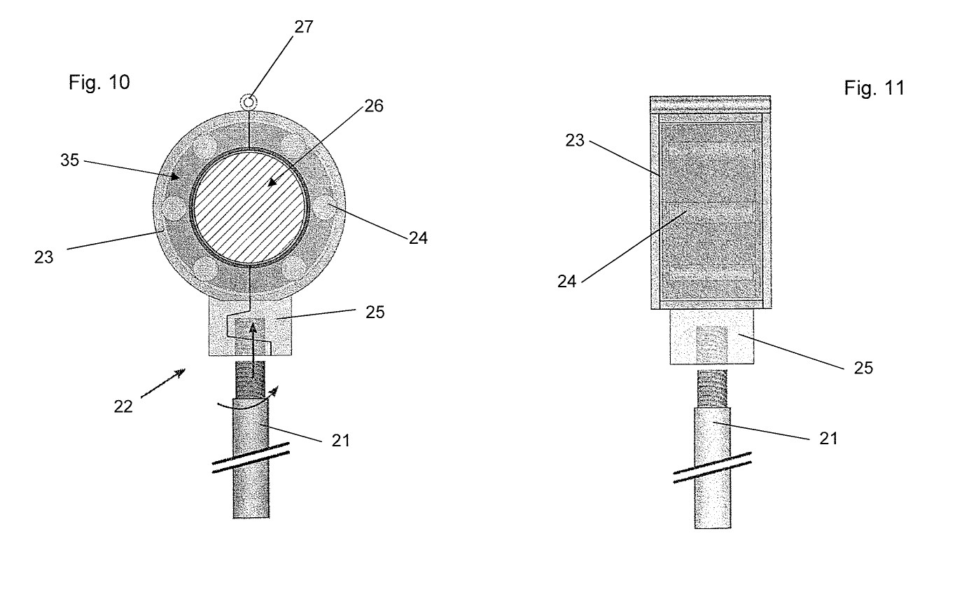

In any number of embodiments, an alternative design of a base is used such that a flag arm 21 is removable. As shown in FIGS. 8 and 9, for example, a flag display assembly 20 comprises a base 22, a flag arm 21, at least one clip 18 and an end cap 19. The flag arm 21 can be substantially straight and cylindrical in shape and attaches to the base 22 in order to keep a flag at a straight 90 degree angle to a flag pole. As shown in FIG. 10, for example, the base 22 comprises a hinged casing 23, an interior roller bearing assembly 35, and a threaded receiving end 25. Furthermore, one end of the flag arm 21 is threaded such that it can be screwed into a threaded receiving end 25 of the base 22. The outer casing 23 can be substantially cylindrical in shape, as shown in FIG. 10 for example. Other shapes are contemplated. Regardless of the outer shape of the casing 23, when the casing is in the closed position, a substantially cylindrical cavity 26 is formed in the center of the casing to fit around a flag pole.

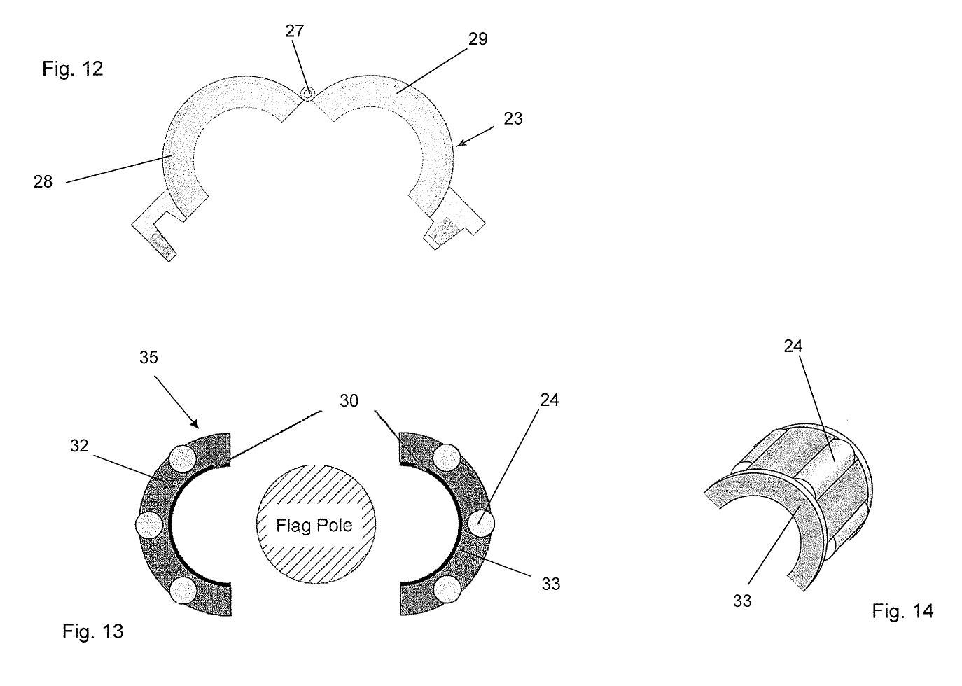

As shown in FIG. 12, for example, the outer casing 23 comprises a first side 28, a second side 29 and a hinge 27 connecting the first side to the second side. The interior edges of the first and second sides 29, 27 are curved such that a substantially cylindrical cavity 26 is formed when the casing is in the closed position. A roller bearing assembly 35 that fits inside the casing 23 is depicted in FIGS. 13 and 14, for example. The roller bearing assembly 35 comprises a first roller bearing housing member 32, a second roller bearing housing member 33, a rubber lining 30 and at least one roller bearing 24. The rubber lining 30 covers the interior edge of the first and second housing member 32, 33. The roller bearings 24 are secured within the first and second housing members 32, 33 such that each roller bearing slightly protrudes past the exterior edge of the housing member, as shown in FIG. 14, for example. When the outer casing 23, with the roller bearing assembly 35 inside, is closed around a flag pole, the rubber lining 30 sits between the flag pole and the roller bearing housing members 32, 33 to provide grip and to prevent vibration from being transferred to the flag pole. Therefore, the first and second housing members 32, 33 do not rotate around the flag pole. However, the outer casing 23 is able to rotate 360 degrees around the roller bearing assembly 35. The roller bearings 24 facilitate this rotation of the outer casing 23 because each roller bearing 24 is able to spin within the housing member. In an alternative embodiment, a friction reducing material is used on the outer surface of each housing member in place of roller bearings. Once the outer casing is closed around a flag pole as shown in FIG. 10, for example, the flag arm 21 is screwed into place, thereby locking the outer casing 23 closed. Because the flag arm 21 is attached to the outer casing 23 of the base 22, the flag arm 21 is able to rotate with the outer casing 23 as it rotates around the roller bearing assembly 35.

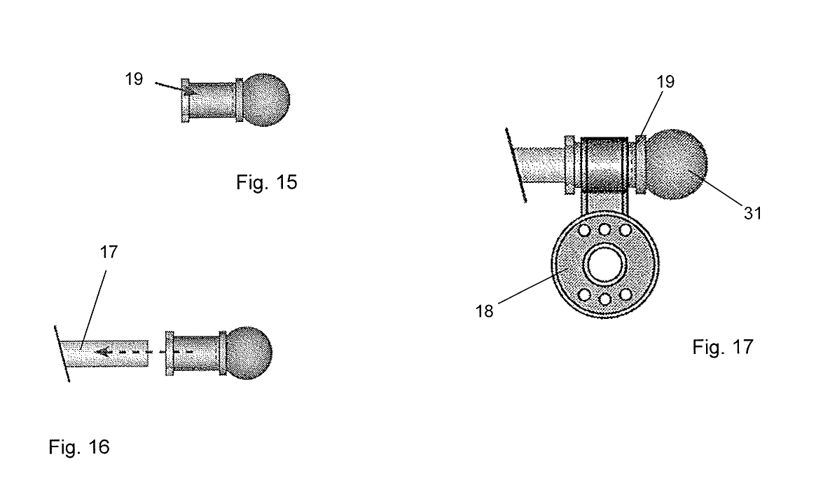

In any number of embodiments, as shown in FIGS. 8 and 15, for example, an end cap 19 is included on one end of a flag arm. The end cap 19 can be permanently or removeably attached to the flag arm. In an embodiment, the end cap 19 can be hollow and configured to slide onto the flag arm, as shown in FIG. 16. Alternatively, the end cap 19 includes a hollow and threaded receiving end that receives a threaded end of a flag arm. Furthermore, as shown in FIG. 17, the end cap 19 can be substantially cylindrical in shape and sized to fit a clip 18 if desired. The end 31 of the end cap 19 can be rounded, for example, to prevent injury from a sharp end or point of the flag arm.

In any number of embodiments, at least one clip 18 is used to secure a flag 15 to a flag arm 17 of the flag display assembly 14. As shown in FIG. 1, for example, more than one clip 18 can be evenly spaced along the flag arm 17 to secure the flag 15 at multiple locations. This ensures a stronger hold on the flag 15 and prevents the flag from folding over itself and thereby obscuring the flag image. The number of clips 18 used and the spacing between clips can vary depending on the size of the flag and user preference.

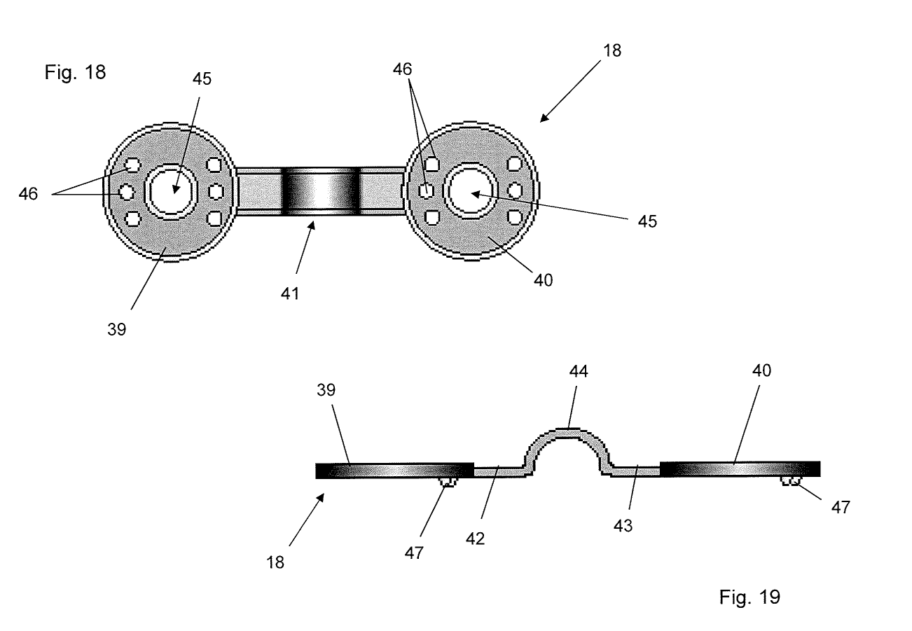

Clips which may be suitable for use with the present invention such as, for example, fabric clips, are known in the art. Several exemplary clips that can be used with the flag display assembly are described herein. An embodiment of a clip 18 is shown in FIGS. 18 and 19, for example. The clip 18 comprises a first end 39, a second end 40 and a connector segment 41 that connects the first and second ends. As shown in FIG. 19, the connector segment 41 comprises a first segment 42 attached to the first end 39, a second segment 43 attached to the second end 40 and a connector segment 44 connecting the first and second segments 42, 43. The first and second segments 42, 43 are substantially straight and flat. The connector segment 44 is curved and substantially U-shaped. The first and second ends 39, 40 are substantially cylindrical in shape and each contain a substantially cylindrical cut-out 45 in the center of each end, such that each end forms a donut shape. Each cut-out 45 helps secure the flag 15 when the clip is in the closed position.

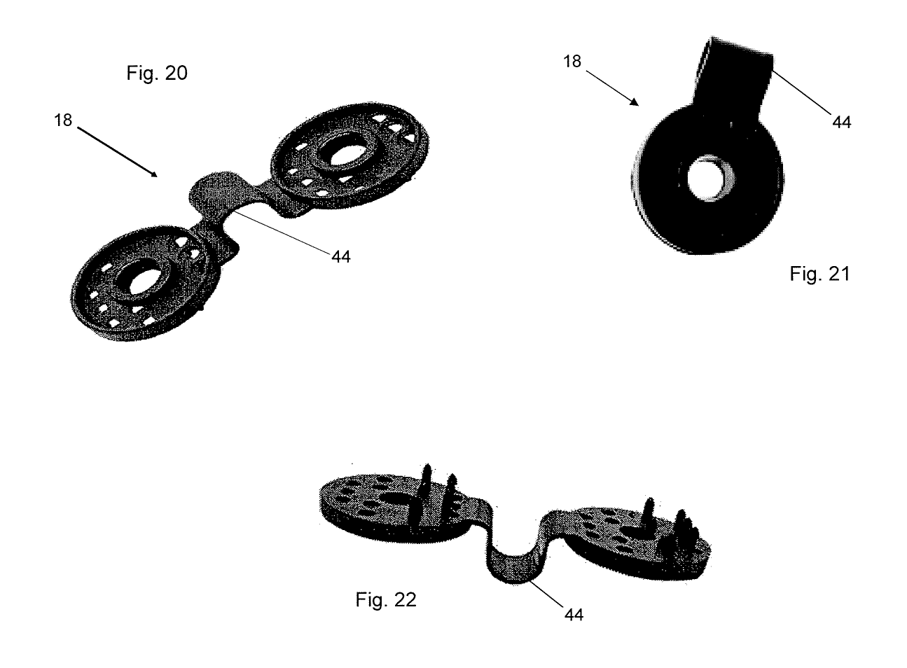

As shown in FIG. 18, the first and second ends 39, 40 further contain at least one small hole 46. On the bottom surface of the first and second ends 39, 40, as shown in FIG. 19, at least one prong 47 extends from the bottom surface of each end. The clip can be formed from plastic, for example. The connector segment 41 must be formed from a flexible material such that the connector segment 41 can be bent or folded when the clip is closed. To close the clip 18, the connector segment 41 is folded in half such that the bottom surface of the first end 39 is adjacent to and flush against the bottom surface of the second end 40. Furthermore, when in the closed position, a prong 47 extending from the bottom surface of the first end 39 fits into a corresponding hole 46 found in the second end 40. Similarly, a prong 47 extending from the bottom surface of the second end 40 fits into a corresponding hole 46 found in the first end 39. More than one prong 47 can extend from the bottom surfaces of each end and fit into additional small holes on the opposite ends, as shown in FIG. 22, for example. FIG. 21 is a photograph of a clip 18 in the closed position. As shown in FIGS. 3, and 19 through 22, for example, the curved U-shape of the connector segment 44 fits over and around a flag arm 17.

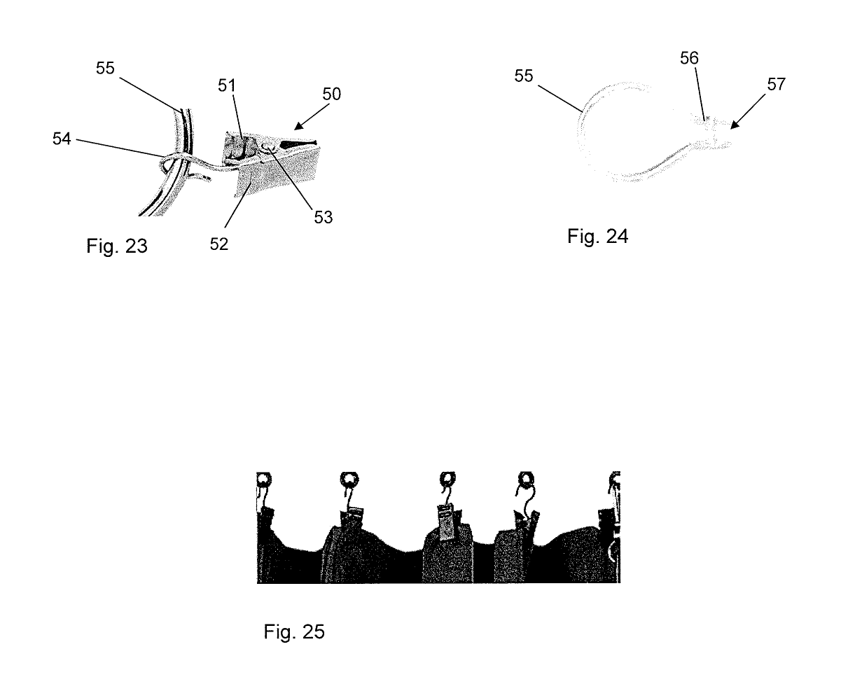

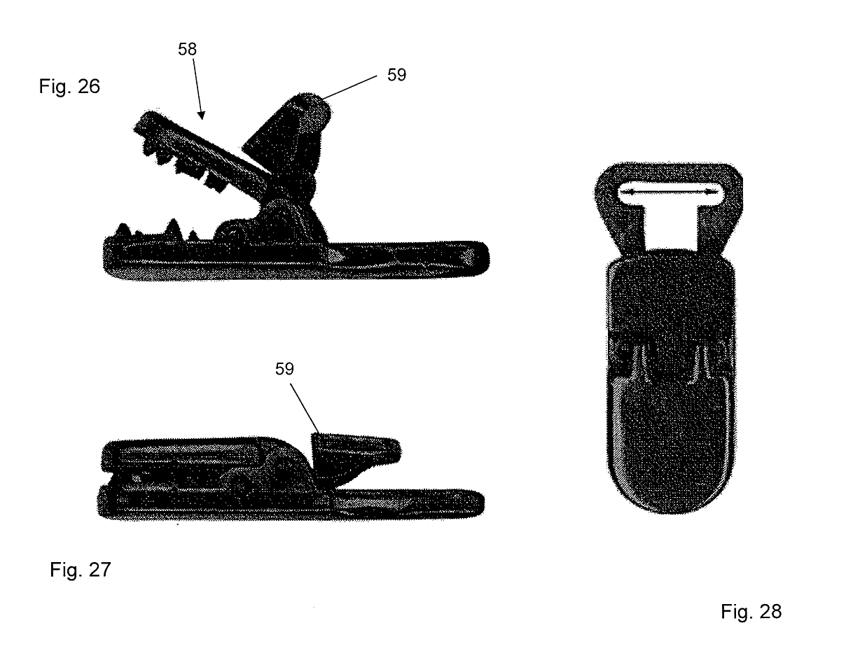

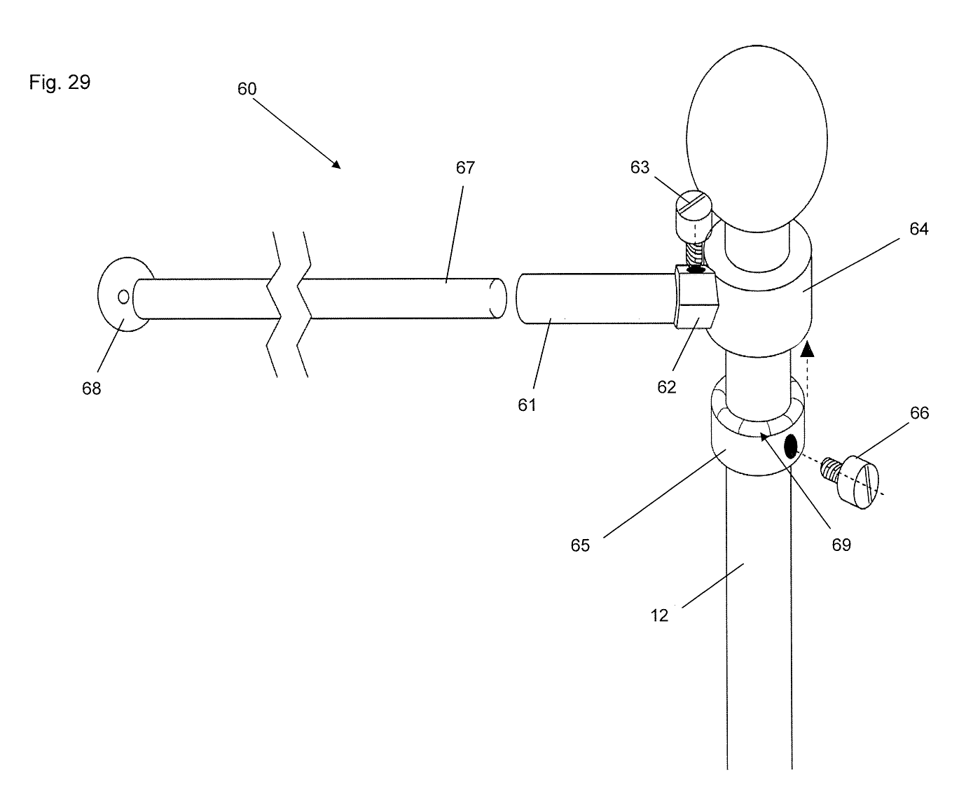

FIGS. 23 through 25 show an alternative embodiment of a flag clip 50. As shown in FIG. 23, the clip 50 comprises a first side 51, a second side 52 and a means for attaching the first side to the second side 53 such that the top ends of each side touch one another when at rest which is also the closed position. The clip further comprises a hooked segment 54 extending from the bottom end of the second side 52. To open the clip 50, the bottom ends of each side are pressed together such that the top ends of each side move away from each other. As shown in FIG. 24, a clip ring 55 is substantially cylindrical in shape and comprises a connection end 57 and means for opening and closing the clip ring 56. The clip ring is installed on a flag arm 17 such that the connection end 57 rests on the flag arm 17 and the clip ring hangs down from the flag arm 17. The hooked segment 54 is then hooked onto the clip ring 55 and the clip 50 is clipped to a flag 15 as shown in FIG. 25, for example. FIGS. 26 through 28 show an alternative embodiment of a flag clip 58. A release and lock mechanism 59 is pulled up to open the clip and pushed down to close the clip. Similar to flag clip 50, flag clip 58 can attach to a flag ring 55 hanging from a flag arm 17.

FIG. 29 depicts an alternative embodiment of the flag display assembly 60. Elements of the flag display assembly 60 as shown include: a flag arm 67; a support collar 65; an arm connector 61; and a flag arm coupler 64. The flag display assembly 60 further includes means for attaching a flag to the flag arm 67 including, but not limited to, nylon pull ties, twine, or clips as described herein, etc. A flag 15 that has been specially adapted to fit onto a flag display assembly can be used in place of clips as previously described. The flag display assembly 60 further includes an end cap (also referred to as a ball end) 68. The end cap 68 can be hollow and fit over the flag arm 67 or can be hollow and include a threaded receiving end that a threaded flag arm can screw into. The end cap can also be permanently attached to the flag arm 67. The flag arm 67 can be a substantially straight and cylindrical rod that attaches to the top edge of a flag 15. The flag arm 67 can be hollow in any number of embodiments. The flag arm may be made from any number of materials such as plastic or metal. Plastic or light-weight metals such as aluminum, for example, are preferable. As described herein, the flag arm 67 has a length L3 which is preferably equal to or slightly longer than the top edge of the flag 15. The flag arm 67 is permanently or removeably attached to the flag arm coupler 64. The flag arm coupler 64 fits onto a flag pole 12 and the flag arm coupler 64 is able to rotate 360 degrees around a flag pole 12. In addition, the flag arm coupler 64 can be adjustable to accommodate different sized flag poles.

In an embodiment, as shown in FIG. 29, for example, an arm connector 61 may be used to attach the flag arm 67 to a flag arm coupler 64. The arm connector 61 can be a short straight and cylindrical segment that slides into a hollow receiving end 62 of a flag-arm coupler 64. The arm connector 61 is retained by a threaded bolt 63, for example. The flag arm 67 can be at least partially hollow on one end such that it can slide over and onto the arm connector 61. Alternatively, the receiving end 62 of the flag-arm coupler 64 can be threaded such that it is able to receive a threaded receiving end of a flag arm 67. The flag-arm coupler 64 has a flag pole 12 passing through it. This coupler 64 has the ability to rotate 360 degrees and is typically placed at the very top of the flag pole 12. The flag-arm coupler can be held in position by the support collar 65 which includes a central cavity for a flag pole 12 to pass through and which is tightly affixed to a flag pole 12 using a threaded bolt 66. The support collar 65 may be adjustable to accommodate different sized flag poles. This support collar 65 may have a radiused contact surface 69 which reduces friction when the flag-arm coupler 64 is rotating. Both the top and bottom surfaces of the support collar 65 can be radiused such that the support collar 65 can be turned over 180 degrees when one surface is worn thereby extending the life of the support collar 65. Both the flag arm coupler 64 and the support collar 65 can be sized to fit different sizes of flag poles 12.

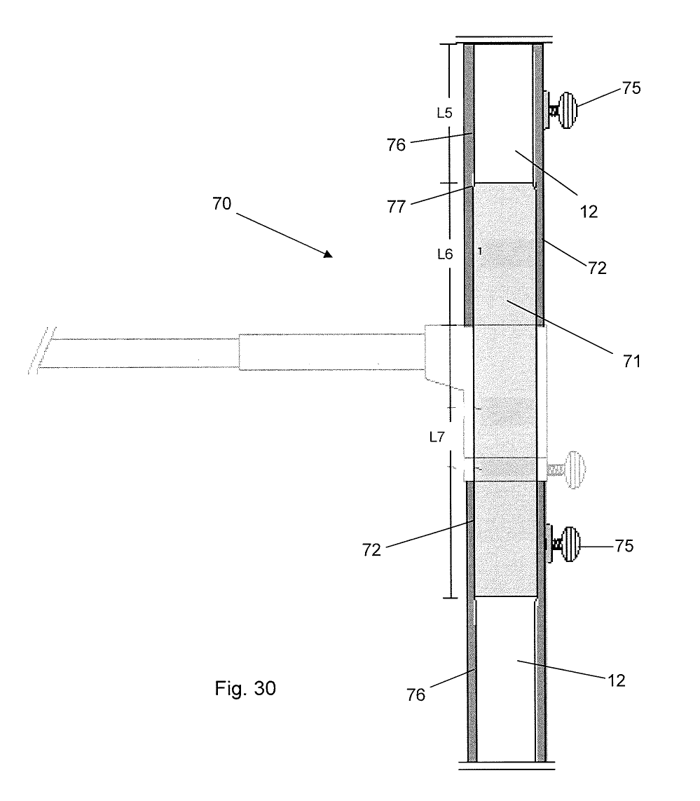

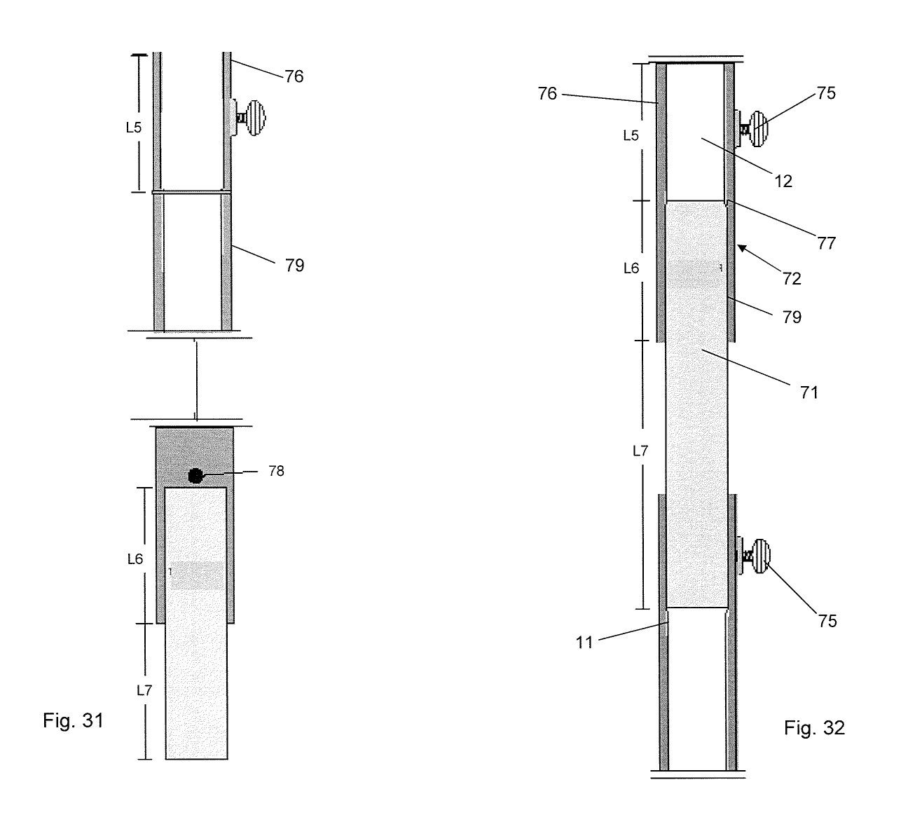

In any number of embodiments, an extension assembly 70 may be utilized to extend the length of the flag pole 12. As shown in FIG. 30, for example, an extension assembly 70 can be used to connect two flag poles 12 to one another. The extension assembly 70 comprises two main components: a hollow outer casing 72 and a connection pin 71. The hollow outer casing 72 and the connection pin 71 may be permanently attached to one another or separable. As shown in FIGS. 30 and 31, for example, the hollow outer casing 72 has two ends: a female end 76 and a male end 79 which meet at an intersection line 77. The female end 76 is hollow such that an internal receiving cavity is formed that has an internal diameter which is large enough to receive a flag pole 12. Once inserted into the female end 76, the flag pole 12 can be secured with a means for attachment, including, but not limited to a thumb screw 75 or a weep hole 78 system. The female end 76 has a length L5. Length L5 can vary to fit different sizes of poles. In a preferred embodiment, length L5 is three times the diameter of the pole to achieve maximum strength. In an embodiment, for example, L5 is 3″ to fit a 1″ diameter pole. The male end 79 is hollow such that an internal receiving cavity is formed that has an internal diameter which is large enough to receive a connection pin 71. Within the second end 79 of the outer casing 72, the diameter can be machined, reducing it to a diameter slightly smaller or slightly larger than the internal diameter of the female end 76. The male end 79 has a length L6 which can vary depending on the size of the connection pin 71. In an embodiment, for example, L6 is 3″. The extension assembly 70 further comprises a connection pin 71 that can be made from plastic or metal such as steel or aluminum. The connection pin 71 can be a substantially straight and cylindrical rod that will extend beyond the outer casing 72 a length of L7 when the pin is fully inserted into the male end 79 of the casing. In some embodiments, the pin 71 is permanently attached to the outer casing 72. In some embodiments, the pin 71 has the same outer diameter as a flag pole, such that the pin acts as an extended flag pole. As shown in FIG. 30, for example, two extension assemblies 70 can be utilized together to connect two separate flag poles 12. Further, as shown in FIG. 30, for example, the flag display assembly can be attached to the exposed length of the connection pin if desired. In an alternative embodiment, as shown in FIG. 32, for example, the extending length L7 of the connection pin 71 can be inserted into a mounting sleeve 11 and secured with a means for attachment, including, but not limited to a thumb screw 75 or a weep hole 78 system.

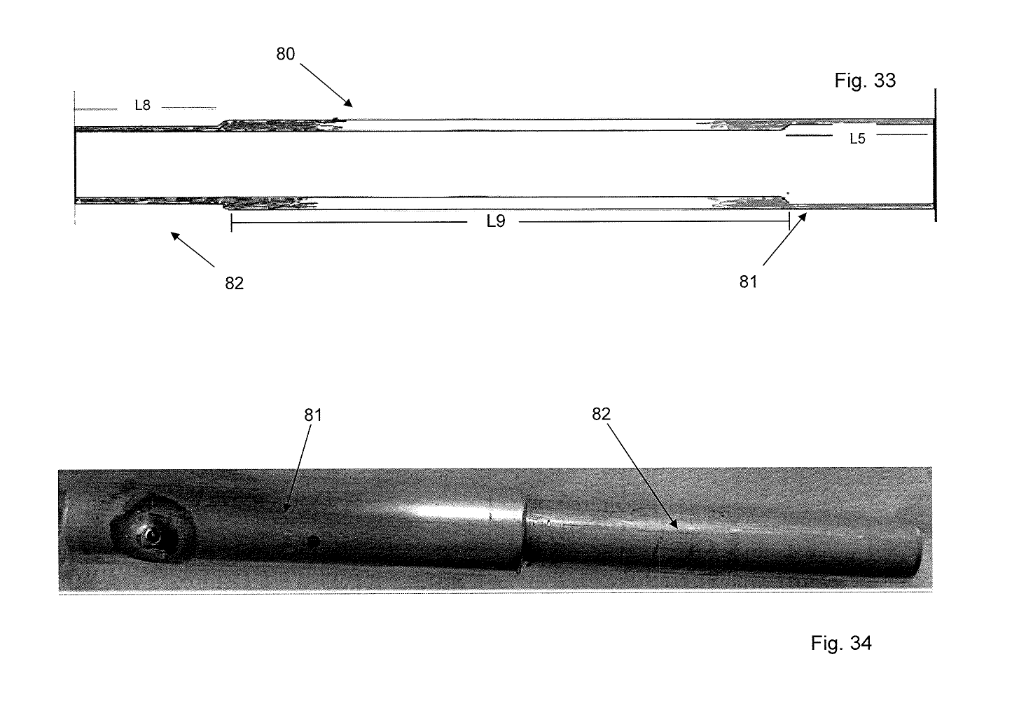

As shown in FIGS. 33 and 34, for example, the extension assembly can also comprise once piece with a first end 81 and a second end 82 connected by a center segment 80. The first end 81 has a larger outer diameter but is at least partially hollow such that an internal receiving cavity is formed that has an internal diameter which is large enough to receive a flag pole 12. Once inserted into the first end 81, the flag pole 12 can be secured with a means for attachment, including, but not limited to a thumb screw 75 or a weep hole 78 system. The first end 81 has a length L5. Length L5 can vary to fit different sizes of poles. The center segment 80 can have the same outer diameter as the first end 81, but it does not necessarily have the same interior diameter as the first end 81. In fact, as shown in FIG. 33, the interior diameter of the center segment 80 is sized slightly smaller than the interior diameter of the first end 81. In some embodiments, the center segment 81 is not hollow. The center segment has length L9. The extension assembly further comprises a second end 82 which extends out of the center segment 80. This second end 82 has an exterior diameter slightly smaller than the exterior diameter of the center segment 80 and the first end 81. The second end 82 has length L8 and the exterior diameter is sized such that it can fit into the pole receiving first end 81 of a second extension assembly, a mounting sleeve 11, or any other place a pole 12 can fit, for example. The length L8 can vary depending on how much a user wants to extend the flag pole.

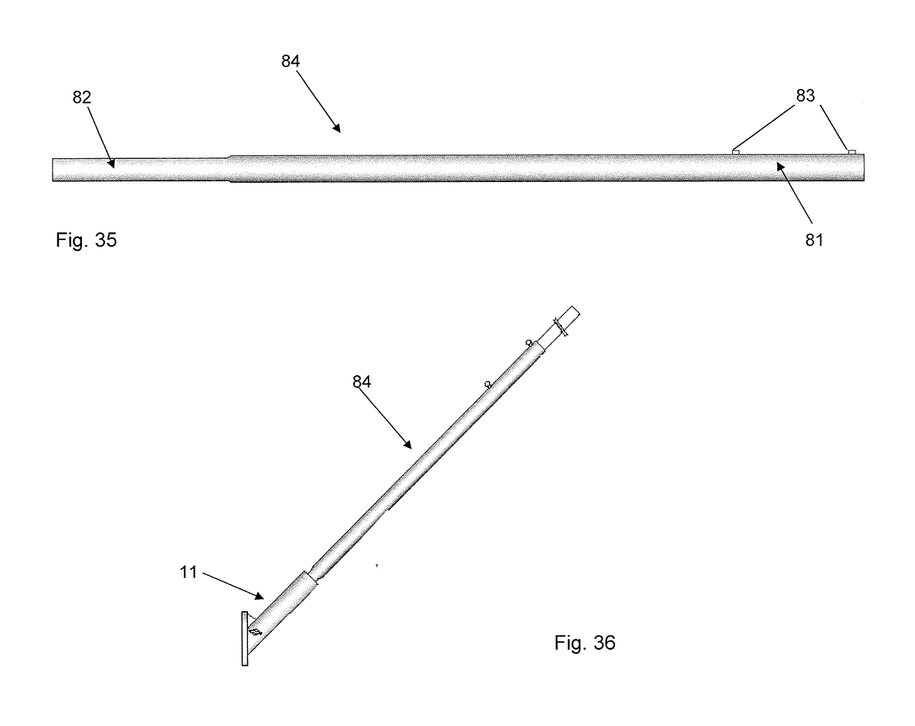

An extension assembly 84 can also exclude the center segment 81 and only comprise a first end 81 and a second end 82, as shown in FIGS. 34 and 35, for example. The first end 81 has an outer diameter that can be slightly larger than the exterior diameter of a flag pole 12. The first end 81 is at least partially hollow such that an internal receiving cavity is formed that has an internal diameter which is large enough to receive a flag pole 12. Locking screws 83 lock a flag pole 12 in place. The second end (also referred to as the flag pole extender) 82 has an external diameter substantially equal to the diameter of a flag pole, such that the second end 82 acts as an extension piece for a flag pole. The outer diameter of the second end 82 widens as you move to the first end 81. As shown in FIG. 36, for example, the flag pole extension assembly 84 can fit into a mounting sleeve 11.

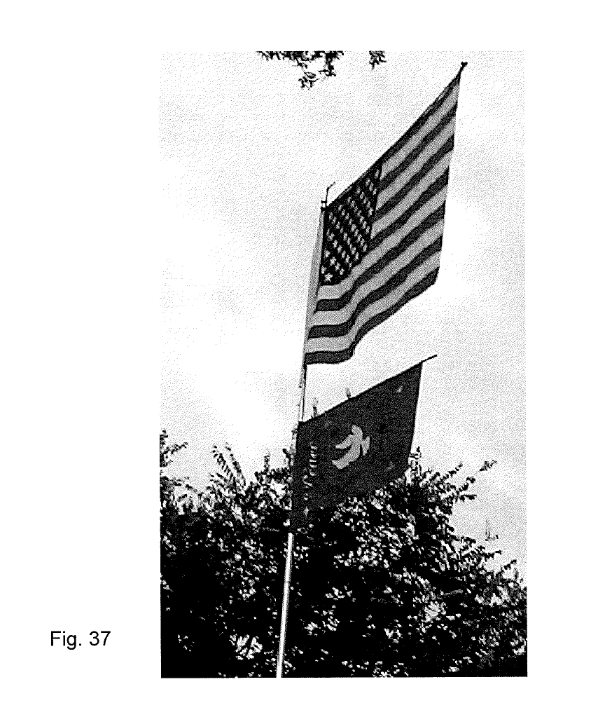

As shown in FIG. 37, for example, multiple flag display assemblies can be installed on a single flag pole or onto an extended flag pole. By using multiple flag display assemblies, more than one flag can be displayed on a single pole.

The dimensions described herein will be understood to be exemplary and provided as embodiments associated with proper working operation of the present invention. Furthermore, while the preferred embodiment disclosed herein is a rectangular flag display assembly, alternative shapes and sizes of fabrics are to be considered. For example, a flag as described herein could be a square, a circle or any other shape.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed is:

1. A flag display assembly comprising:
a flag arm configured to support an edge of a flag; and
a base configured to attach to a flag pole, wherein said flag arm is secured to said base and wherein said base is configured to allow said flag arm to rotate about said flag pole.

2. The flag display assembly of claim 1, wherein said flag arm is configured to support said edge of said flag such that substantially all of said flag is visible when said flag is at rest.

3. The flag display assembly of claim 1, further comprising a support member configured to attach to said flag pole and maintain said base at a position along a length of said flag pole.

4. The flag display assembly of claim 1, wherein said base comprises a friction-reducing element configured to facilitate rotation of said flag arm about said flag pole.

5. The flag display assembly of claim 4, wherein said friction-reducing element comprises a roller bearing.

6. The flag display assembly of claim 4, further comprising a support member configured to attach to said flag pole and maintain said base at a position along a length of said flag pole, and wherein said friction-reducing element comprises an upper contact surface of said support member, said upper contact surface being configured to come into contact with a lower portion of said base and to provide relatively low friction between said upper contact surface and said lower portion.

7. The flag display assembly of claim 6, wherein said upper contact surface comprises a radiused contact surface.

8. The flag display assembly of claim 1, wherein said flag display assembly is adjustable such that said flag display assembly can be used with flag poles having different diameters.

9. The flag display assembly of claim 1, wherein said base comprises an outer casing and a friction-reducing element disposed within said outer casing.

10. The flag display assembly of claim 9, wherein said outer casing is formed in a clamshell configuration comprising a first section and a second section joined together by a hinge.

11. The flag display assembly of claim 10, wherein said flag arm and said base are separable and wherein said base comprises a threaded aperture configured to receive a threaded end of said flag arm.

12. The flag display assembly of claim 11, wherein said threaded aperture is defined by both said first section and said second section when said outer casing is in a closed configuration, and wherein said outer casing is configured such that receiving said threaded end of said flag arm within said threaded aperture operates to lock said outer casing in said closed position.

13. The flag display assembly of claim 9, wherein said friction-reducing element comprises a roller bearing assembly comprising at least one roller bearing.

14. The flag display assembly of claim 9, wherein said roller bearing assembly comprises an inwardly-disposed lining configured to facilitate secure attachment of said base to said flag pole.

15. The flag display assembly of claim 1, further comprising attachment members spaced along a length of said flag arm, said attachment members configured to permit attachment of said flag arm to said edge of said flag.

16. The flag display assembly of claim 1, wherein said attachment members comprise a plurality of clips.

17. The flag display assembly of claim 1, further comprising said flag, wherein said edge of said flag comprises an upper edge, and wherein said upper edge of said flag comprises a sleeve configured to receive said flag arm.

18. The flag display assembly of claim 1, further comprising an end cap disposed on an end of said flag arm.

19. The flag display assembly of claim 18, wherein said end cap is removable.

20. A flag display assembly comprising:
a flag arm configured to support an upper edge of a flag;
a plurality of fasteners disposed along a length of said flag arm, said fasteners configured to attach said upper edge of said flag to said flag arm;
a base configured to be secured to a flag pole, said base being attached to and supporting said flag arm;
a support member configured to be secured to said flag pole and to support said base at a position along a length of said flag pole; and
a friction-reducing element, said friction-reducing element configured to facilitate rotation of said flag arm about said flag pole.
